(19) United States
(12) Patent Application Publication
(10) Pub. No.: US 2018/0205932 A1
(43) Pub. Date: Jul. 19, 2018

(54) STEREOSCOPIC VIDEO SEE-THROUGH AUGMENTED REALITY DEVICE WITH VERGENCE CONTROL AND GAZE STABILIZATION, HEAD-MOUNTED DISPLAY AND METHOD FOR NEAR-FIELD AUGMENTED REALITY APPLICATION

(71) Applicants: National Taiwan University, Taipei (TW); MediaTek Inc., Hsinchu City (TW)

(72) Inventors: Tzu-Chieh Yu, New Taipei City (TW); Yu-Hsuan Huang, Taipei (TW); Te-Hao Chang, Hsin-Chu City (TW); Ming Ouh Young, Taipei (TW)

(21) Appl. No.: 15/642,519

(22) Filed: Jul. 6, 2017

(30) Foreign Application Priority Data
Jan. 16, 2017 (TW) 106101450

(51) Int. Cl. H04N 13/00; H04N 13/04; H04N 13/02; G06T 11/60; H04N 5/232

(52) U.S. Cl. CPC H04N 13/0033; H04N 13/0484; H04N 5/2328; H04N 13/0296; G06T 11/60; H04N 13/044

(57) ABSTRACT

The present invention provides a see-through augmented reality device coupled to a head-mounted display, the device comprises: a camera configured to capture an image; a 2-axis gimbal coupled to the camera and configured to stabilize the camera; a servo motor coupled to the camera and configured to control the rotations of the camera; a microcontroller coupled to the servo motor and configured to control the servo motor; a multiplexer coupled to the microcontroller and configured to decode signals received from the microcontroller; and an augmented reality image processor coupled to the camera and configured to combine a virtual object with the image captured by the camera to create a virtual-real image and transfer the virtual-real image to the head-mounted display.

### CROSS-REFERENCE TO RELATED APPLICATIONS

This Non-provisional application claims priority under 35 U.S.C. § 119(a) on Patent Application No(s). 106101450 filed in Taiwan, Republic of China, on Jan. 16, 2017; the entire contents of which are hereby incorporated by reference.

### FIELD OF THE INVENTION

The present invention provides a see-through augmented reality device which is vergence controlled and gaze stabilized; in particular, the see-through augmented reality is mounted on a head-mounted display.

### BACKGROUND OF THE INVENTION

Augmented reality (AR) has become a hot topic because of the recent development on mobile applications and games. AR is a technology that combines calculations of locations and angles from images captured by a camera in real time with a related image processing technology. AR technology aims to superimpose a virtual world in a display to the real world for users to interact. Users are entertained by wearing a head-mounted display equipped with an AR technology facilitated by mobile applications running on mobile phones and/or tablets.

A commonly seen see-through head-mounted display (HMD) with AR technology requires two cameras in front of the HMD to capture images on a user's view of the real word. A virtual object and the real word images are then computer-processed and overlaid to display on the HMD. The common design however fails to consider movements of human eyes. Even when a human being's head is heavily shaking, human eyes are still able to focus at a particular point and gaze at the same direction. Moreover, the effect of eye movement further helps object focus in a short distance.

The failures to simulate the effect of eye movement and be vergence controlled and gaze stabilized, the market ready HMDs are unable to quickly focus objects in a short distance. The inconvenience may cause delays on tracking objects and, as a result, users would not be able to enjoy the funs brought by HMDs. Given that, there is a desire to design a simple, light and easy to use augmented reality head-mounted display (AR-HMD).

### SUMMARY OF THE INVENTION

Accordingly, the present invention provides a see-through augmented reality device which is vergence controlled and gaze stabilized. The see-through augmented reality device is amounted on a head-mounted display. The see-through augmented reality device has a servo motor that controls a stereo camera stabilized by a 2-axis gimbal. The present see-through augmented reality device is capable of simulating the effect of eye movement, thus, the images therefore captured by the stereo camera are vision stabilized and identical to what a human being would actually see in the real world.

The see-through augmented reality device coupled to a head-mounted display, the device comprises: a camera configured to capture an image; a 2-axis gimbal coupled to the camera and configured to stabilize the camera; a servo motor coupled to the camera and configured to control the rotations of the camera; a microcontroller coupled to the servo motor and configured to control the servo motor; a multiplexer coupled to the microcontroller and configured to decode signals received from the microcontroller; and an augmented reality image processor coupled to the camera and configured to combine a virtual object with the image captured by the camera to create a virtual-real image and transfer the virtual-real image to the head-mounted display.

Preferably, the see-through augmented reality device further comprises an instruction device that instructs the servo motor to move.

Preferably, it is preferred that the see-through augmented reality device comprises a pair of 2-axis gimbal, a pair of camera, and a pair of servo motor.

Preferably, the optical axis of the servo motor is identical to the nodal point of the camera.

Preferably, the camera comprises a fisheye lens.

Preferably, the increment of the servo motor is 0.29 degree.

The present invention provides a head-mounted display, comprising: a screen; and a see-through augmented reality device coupled thereto, wherein the see-through augmented reality device comprises: a camera configured to capture an image; a 2-axis gimbal coupled to the camera and configured to stabilize the camera; a servo motor coupled to the camera and configured to control the rotations of the camera; a microcontroller coupled to the servo motor and configured to control the servo motor; a multiplexer coupled to the microcontroller and configured to decode the signals received from the microcontroller; and an augmented reality image processor coupled to the camera and configured to combine a virtual object with the image captured by the camera to create a virtual-real image and transfer the virtual-real image to the head-mounted display.

The present invention provides a method for augmenting an object in a near field comprising: wearing a head-mounted display on a user's head; capturing an image via a camera; controlling a servo motor by a microcontroller causing the camera to mimic the inward and outward movements of eyes, wherein the camera is stabilized by using a 2-axis gimbal; combining a virtual object with the image captured by the camera to create a virtual-real image via an augmented reality image processor; and transferring the virtual-real image to a head-mounted display for an user's viewing.

Preferably, the image captured by the camera distances at about 10 cm to 30 cm from the camera.

### BRIEF DESCRIPTION OF THE DRAWINGS

FIG. 1 is the schematic diagram of one embodiment of the see-through augmented reality device with vergence control and gaze stabilization of the present invention.

FIG. 2 is the schematic diagram of another embodiment of the see-through augmented reality device with vergence control and gaze stabilization of the present invention.

FIG. 3 is the augmented reality process flowchart of the present invention.

FIG. 4 is the near-field augmented reality method process flowchart of the present invention.

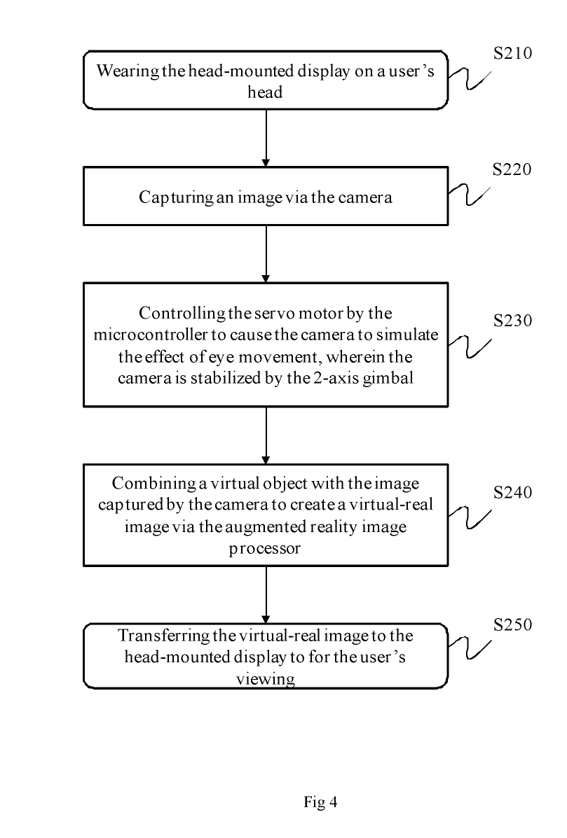

### DETAILED DESCRIPTION OF THE INVENTION

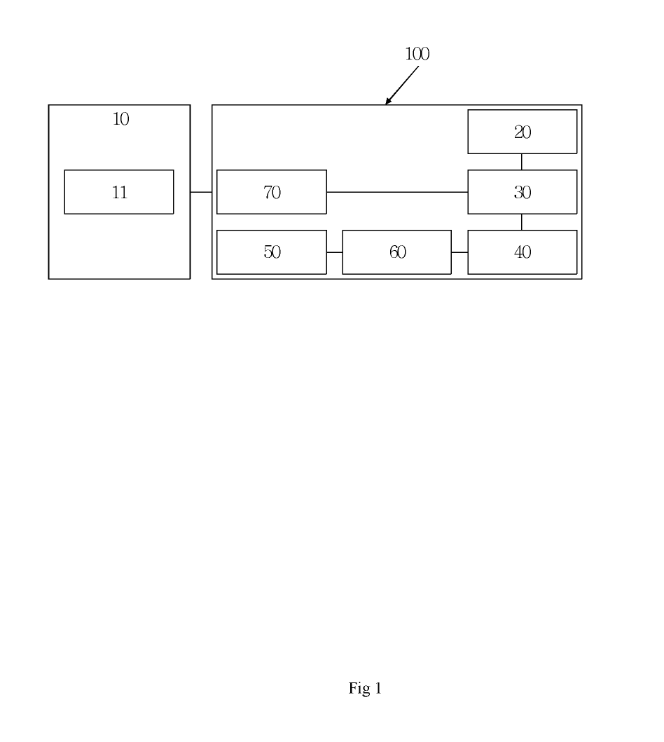

FIG. 1 is a schematic diagram of one embodiment of the see-through augmented reality device with vergence control and gaze stabilization of the present invention. As shown in FIG. 1, the see-through augmented reality device 100 of the present invention is coupled to a head-mounted display, wherein the head-mounted display 10 comprises a screen 11 and the see-through augmented reality device 100. The see-through augmented reality device 100 comprises a camera 30 configured to capture an image; a 2-axis gimbal 20 coupled to the camera 30 and configured to stabilize the camera 30; a servo motor 40 coupled to the camera 30 and configured to control the rotations of the camera 30; a microcontroller 60 coupled to the servo motor 40 and configured to control the servo motor 40; a multiplexer 50 coupled to the microcontroller 60 and configured to analysis of the signals received from the microcontroller 60; and an augmented reality image processor 70 coupled to the camera 30 and configured to combine a virtual object with the image captured by the camera 30 to create a virtual-real image and transfer the virtual-real image to the head-mounted display 11.

In one embodiment, the see-through augmented reality device 100 further comprises an instruction device (which is not shown in the figures) to instruct the servo motor 40 to move in accordance with the instructing signals from a user, and control the camera 30 to move inwardly or outwardly to see the objects within different distances. Besides, the servo motor 40 analyses and adjusts the movement based on the feedback signals from microcontroller 60 and multiplexer 50.

In one embodiment, it is preferred that the see-through augmented reality device 100 comprises a pair of 2-axis gimbal 20, a pair of camera 30, and a pair of servo motor 40. A camera 30, a 2-axis gimbal 20 and a servo motor 40 are coupled to each other, so that each camera 30 could be controlled by a servo motor 40 and could be stabilized by a 2-axis gimbal 20.

In one embodiment, the optical axis of the servo motor 40 is identical to the nodal point of the camera 30, so as to simulate the structure of the human eye.

In one embodiment, the camera is preferably an industrial camera having a higher resolution (more than 200 million pixels) so as to accurately show the captured image. The camera 30 may comprise a fisheye lens with 130 degree field of view (FOV) and 3.55 mm focal length.

In one embodiment, the 2-axis gimbal 20 can be of any kind having a relative stable structure to generate a stable inertia movement while rotating camera 30 so as to keep the initial state steady.

In one of the embodiment, the increment of servo motor 40 is, but not limited to 0.29 degree.

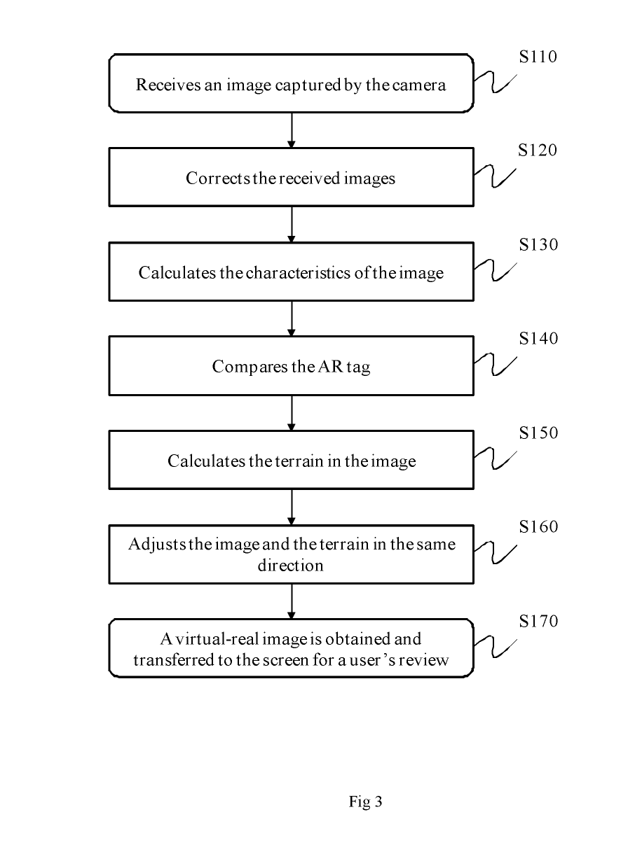

Augmented reality technology superimposes virtual objects on videos/images in the real environment. The techniques underneath may include computer visualization and graphics. Augmented reality can be categorized into two modes, Marker AR and Markerless AR. The present invention is applicable to either one of the two modes. Take the Marker AR mode as an example, a specific marker, known as AR tag, on a captured image is located, tracked, and recognized. FIG. 3 is a flowchart showing the process of the augmented reality. First, the augmented reality image processor 70 receives an image captured by the camera 30 (step S110). The image processor 70 corrects the received images (step S120) and further calculates the characteristics of the image (step S130). The image processor 70 compares the AR tag (step S140) and calculates the terrain in the image (step S150). The image processor 70 adjusts the image and the terrain in the same direction (step S160). Lastly, a virtual-real image is obtained and transferred to the screen 11 for a user's review (step S170).

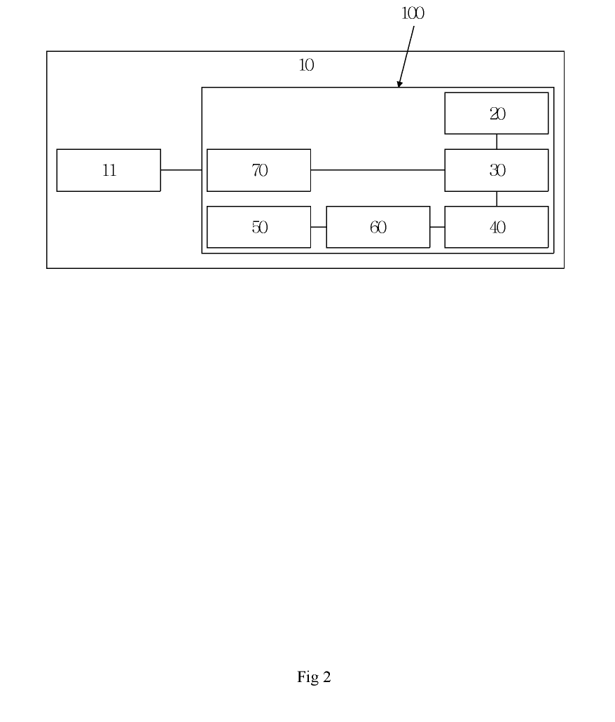

FIG. 2 is the schematic diagram of another embodiment of the see-through augmented reality device of the present invention. As shown in FIG. 2, the see-through augmented reality device 100 can be integrated with the head-mounted display 10. The integrated device has the same units and functions described above.

It is preferred that the head-mounted display 10 comprises a gyroscope (not shown in figure) and a pair of screen 11. It is also preferred that the resolution of the screen 11 is 1200×1080 and the refresh rate is 90 Hz therefore to reduce the delay efficiently.

It is further preferred that the head-mounted display 10 comprises a convex lens to adjust the focal length.

The present invention has two unique features: a gaze stabilization and vergence control. The gaze stabilization is achieved by the combination of the camera 30 and the 2-axis gimbal 20. When a user gazes an object within a short distance, the vision is maintained in the same direction even the user's head is shaking heavily. Further, the vergence control is achieved by the combination of the camera 30 and the servo motor 40. The serve motor 40 controls the left and the right rotations of the camera 30 to simulate the effect of eye movement and therefore to focus objects in different distances. The present invention simulates the effect of eye movement by the unique mechanical structure combining the camera 30, the 2-axis gimbal 20 and the servo motor 40. By using the three components, an object in a near field can be focused precisely and stably.

The present invention further provides a method for augmenting an object in a near-field. The method comprises step S210, wearing the head-mounted display 10 on a user's head; step S220, capturing an image via the camera 30; step S230, controlling the servo motor 40 by the microcontroller 60 to cause the camera 30 to simulate the effect of eye movement, wherein the camera 30 is stabilized by the 2-axis gimbal 20; step S240, combining a virtual object with the image captured by the camera 30 to create a virtual-real image via the augmented reality image processor 70; and step S250, transferring the virtual-real image to the head-mounted display 10 to for the user's viewing.

The achievement of the present invention can be proved by the following experiment. Objects are respectively placed at the distances of 10 cm, 20 cm, and 30 cm from the center of the cameras' lenses. 10 users rates from 1 to 5 to reflect how clear they can see the objects where they are wearing and not wearing the see-through augmented reality device of the present invention. A 5-mark means they can easily look at the objects with no troubles on focusing them; while a 1-mark means that they struggle to focus on the objects. The experiments were conducted three times on each of the 10 users. The result is shown in Table 1.

TABLE 1
Experiment Result
Wearing the AR device of the present invention

| | | | | | | | | | | |
|---|---|---|---|---|---|---|---|---|---|---|
| 10 cm | 4 | 3 | 5 | 4 | 5 | 5 | 4 | 5 | 4 | 5 |
| 20 cm | 5 | 4 | 4 | 5 | 3 | 4 | 5 | 4 | 4 | 5 |
| 30 cm | 5 | 5 | 4 | 5 | 4 | 5 | 4 | 5 | 5 | 5 |

Without Wearing the AR device of the present invention

| | | | | | | | | | | |
|---|---|---|---|---|---|---|---|---|---|---|
| 10 cm | 2 | 1 | 1 | 2 | 3 | 1 | 1 | 2 | 3 | 2 |
| 20 cm | 3 | 3 | 2 | 1 | 2 | 2 | 3 | 3 | 3 | 2 |
| 30 cm | 4 | 3 | 3 | 4 | 3 | 4 | 3 | 3 | 4 | 3 |

As shown, the users would have better experience when wearing the augmented reality device of the present invention. The users are able to see the objects clearly and without having troubles on focusing objects if they are wearing augmented reality device of the present invention.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. A see-through augmented reality device coupled to a head-mounted display, comprising:
a camera configured to capture an image;
a 2-axis gimbal coupled to the camera and configured to stabilize the camera;
a servo motor coupled to the camera and configured to control rotations of the camera;
a microcontroller coupled to the servo motor and configured to control the servo motor;
a multiplexer coupled to the microcontroller and configured to decode signals received from the microcontroller; and
an augmented reality image processor coupled to the camera and configured to combine a virtual object with the image captured by the camera to create a virtual-real image and transfer the virtual-real image to the head-mounted display.

2. The see-through augmented reality device of claim 1 further comprises an instruction device that instructs the servo motor to move.

3. The see-through augmented reality device of claim 1, wherein it is preferred that the see-through augmented reality device comprises a pair of 2-axis gimbal, a pair of camera, and a pair of servo motor.

4. The see-through augmented reality device of claim 1, wherein the optical axis of the servo motor is identical to the nodal point of the camera.

5. The see-through augmented reality device of claim 1, wherein the camera comprises a fisheye lens.

6. The see-through augmented reality device of claim 1, wherein the increment of the servo motor is 0.29 degree.

7. The see-through augmented reality device of claim 1, wherein the see-through augmented reality device is vergence controlled and gaze stabilized.

8. A head-mounted display, comprising:
a screen; and a see-through augmented reality device coupled thereto;
wherein the see-through augmented reality device further comprises:
a camera configured to capture an image;
a 2-axis gimbal coupled to the camera and configured to stabilize the camera;
a servo motor coupled to the camera and configured to control rotations of the camera;
a microcontroller coupled to the servo motor and configured to control the servo motor;
a multiplexer coupled to the microcontroller and configured to decode signals received from the microcontroller; and
an augmented reality image processor coupled to the camera and configured to combine a virtual object with the image captured by the camera to create a virtual-real image and transfer the virtual-real image to the head-mounted display.

9. The head-mounted display of claim 8 further comprises a gyroscope.

10. The head-mounted display of claim 8 further comprises a convex lens.

11. The head-mounted display of claim 8, wherein the see-through augmented reality device is vergence controlled and gaze stabilized.

12. A method for augmenting an object in a near field comprising:
capturing an image via a camera;
controlling a servo motor by a microcontroller causing the camera to simulate the effect of eye movement, wherein the camera is stabilized by using a 2-axis gimbal;
combining a virtual object with the image captured by the camera to create a virtual-real image via an augmented reality image processor; and
transferring the virtual-real image to a head-mounted display for an user's viewing.

13. The method of claim 12, wherein the image captured by the camera distances at about 10 cm to 30 cm from the camera.
